(19) United States
(12) Patent Application Publication
(10) Pub. No.: US 2017/0353315 A1
(43) Pub. Date: Dec. 7, 2017

(54) SECURE ELECTRONIC ENTITY, ELECTRONIC APPARATUS AND METHOD FOR VERIFYING THE INTEGRITY OF DATA STORED IN SUCH A SECURE ELECTRONIC ENTITY

(71) Applicant: OBERTHUR TECHNOLOGIES, Colombes (FR)

(72) Inventors: Emmanuelle DOTTAX, Colombes (FR); Florian GALDO, Colombes (FR); Christophe GIRAUD, Colombes (FR); Jean-Philippe VALLIERES, Colombes (FR)

(73) Assignee: OBERTHUR TECHNOLOGIES, Colombes (FR)

(21) Appl. No.: 15/538,709

(22) PCT Filed: Dec. 17, 2015
(86) PCT No.: PCT/FR2015/053595

§ 371 Date: Aug. 7, 2017

(30) Foreign Application Priority Data
Dec. 23, 2014 (FR) 1463256

(51) Int. Cl. H04L 9/32; H04L 9/14; H04L 9/06; H04L 9/30; H04L 9/00

(52) U.S. Cl. CPC H04L 9/3247; H04L 9/30; H04L 9/006; H04L 9/0631; H04L 9/14

(57) ABSTRACT

Disclosed is a secure electronic entity including a memory unit storing data in the form of multiplets and a processing module designed to receive data from an electronic device. The processing module is designed to determine a proof-of-integrity element in accordance with the data received and at least one portion of the stored multiplets, and to transmit the proof-of-integrity element to the electronic device. Also disclosed is a method for verifying the integrity of data stored in such a secure electronic entity.

### TECHNICAL FIELD TO WHICH THE INVENTION RELATES

The present invention concerns the verification of the integrity of data stored in a secure electronic entity.

It more particularly concerns a secure electronic entity, electronic apparatus and a method for verifying the integrity of data stored in such a secure electronic entity.

The invention applies particularly advantageously when the stored data is at least in part secret and must therefore be encrypted when it is stored outside of the secure electronic entity.

### TECHNOLOGICAL BACKGROUND

Secure electronic entities are known, such as integrated circuit cards or embedded secure elements, that store confidential data, for example secret cryptographic keys, used for example in identification, electronic signature or electronic message encryption applications.

Although these secure electronic entities are designed to render any intrusion into their operation virtually impossible, it is desirable to verify from time to time, for example periodically, the integrity of the data stored in a given electronic entity (i.e. that it has not been degraded).

### OBJECT OF THE INVENTION

In this context, the present invention proposes a secure electronic entity comprising a memory storing data in the form of bytes and a processor module designed to receive data coming from an electronic device, characterized in that the processor module is designed to determine a proof-of-integrity element as a function of the data received and at least a part of the stored bytes and to send the proof-of-integrity element to the electronic device.

Thus the secure electronic entity is designed to return a proof-of-integrity element determined by combining received data and stored bytes. Such a proof element makes it possible to affirm that the stored data (in bytes form) at the moment that the electronic entity receives the data coming from the external electronic device (for example a third party auditor) is indeed that expected, failing which the secure electronic entity could not produce the correct proof element.

According to optional (and therefore non-limiting) features:
the received data represents a random value (generated for example by the electronic device);
the received data designates regions of the memory;
the processor module is designed to determine the proof-of-integrity element as a function of the bytes stored in the regions designated by the received data;
the processor module is designed to determine the proof-of-integrity element in part by means of (i.e. notably by means of) encryption of the stored bytes;
the secure electronic entity comprises a module for executing the encryption as a function of a secret key stored in the electronic entity;
the processor module is designed to determine the proof-of-integrity element by means of a signature function or a hashing function or a message authentication code generator function;
said secure electronic entity is a mobile telephone network access card.

The invention also proposes a cellular telephone comprising a secure electronic entity as proposed hereinabove, for example soldered to the cellular telephone.

The invention also proposes an energy supply meter comprising a secure electronic entity as proposed hereinabove, for example soldered to said meter.

The invention moreover proposes an embedded electronic system for vehicles (for example for motor vehicles) comprising a secure electronic entity as proposed hereinabove, possibly soldered to the electronic system.

The invention further proposes electronic apparatus comprising a near field communication module and a secure electronic entity as proposed hereinabove connected to the near field communication module.

The invention also proposes a method of verifying the integrity of data stored in a secure electronic entity, characterized in that it comprises the following steps:
an electronic device sending data to the secure electronic entity;
the secure electronic entity receiving the data;
determination of a proof-of-integrity element as a function of the received data and at least some of the bytes stored in a memory of the secure electronic unit;
the secure electronic entity sending the proof-of-integrity element to the electronic device.

Such a method may further comprise a step of determining at least some of the data sent at random (for example in the electronic device).

According to a first embodiment, the received data may represent a random value used as a parameter in the application of a function.

According to a second embodiment, the received data may designate regions of the memory; the proof-of-integrity element may in this case be determined as a function of the bytes stored in the regions designated by the received data.

According to other optional features:
the determination of the proof-of-integrity element comprises encryption of the stored bytes;
the encryption of the stored bytes uses a secret key stored in the secure electronic entity;
the proof-of-integrity element is determined by applying a signature function or a hashing function or a message authentication code generator function;
said electronic device is a third party auditor.

### DETAILED DESCRIPTION OF ONE EMBODIMENT

The following description with reference to the appended drawings, provided by way of non-limiting example, will clearly explain in what the invention consists and how it can be reduced to practice.

In the appended drawings:

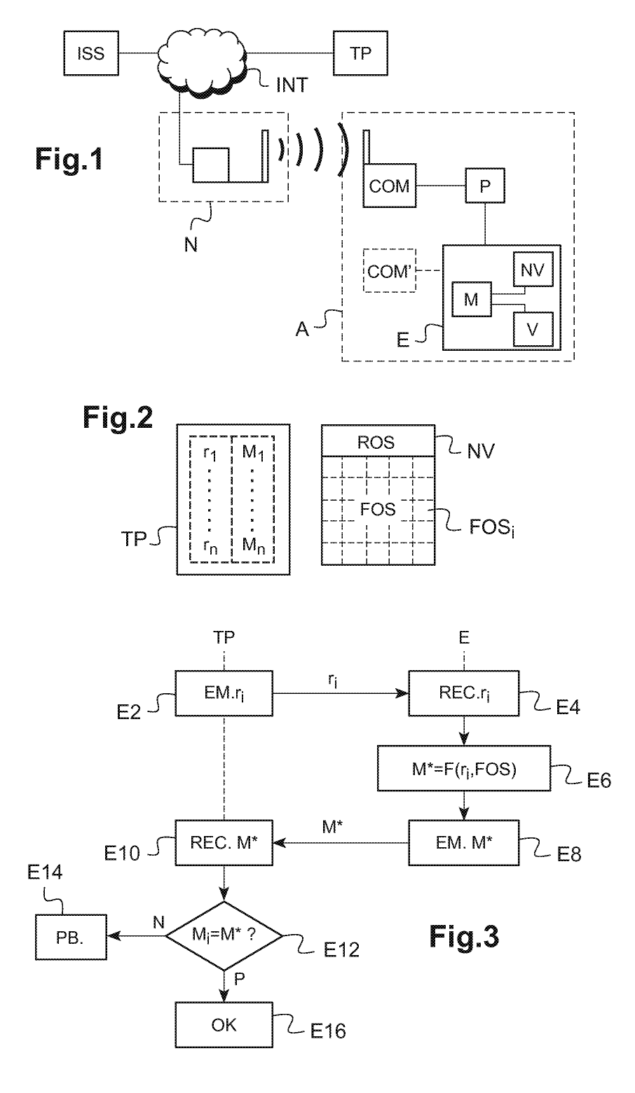

FIG. 1 represents a system in which a secure electronic entity according to the invention is used;

FIG. 2 represents diagrammatically the information stored in a server of a third party auditor and in a non-volatile memory of the secure electronic entity according to a first embodiment of the invention;

FIG. 3 represents the main steps of a first example of a method used in the context of the invention;

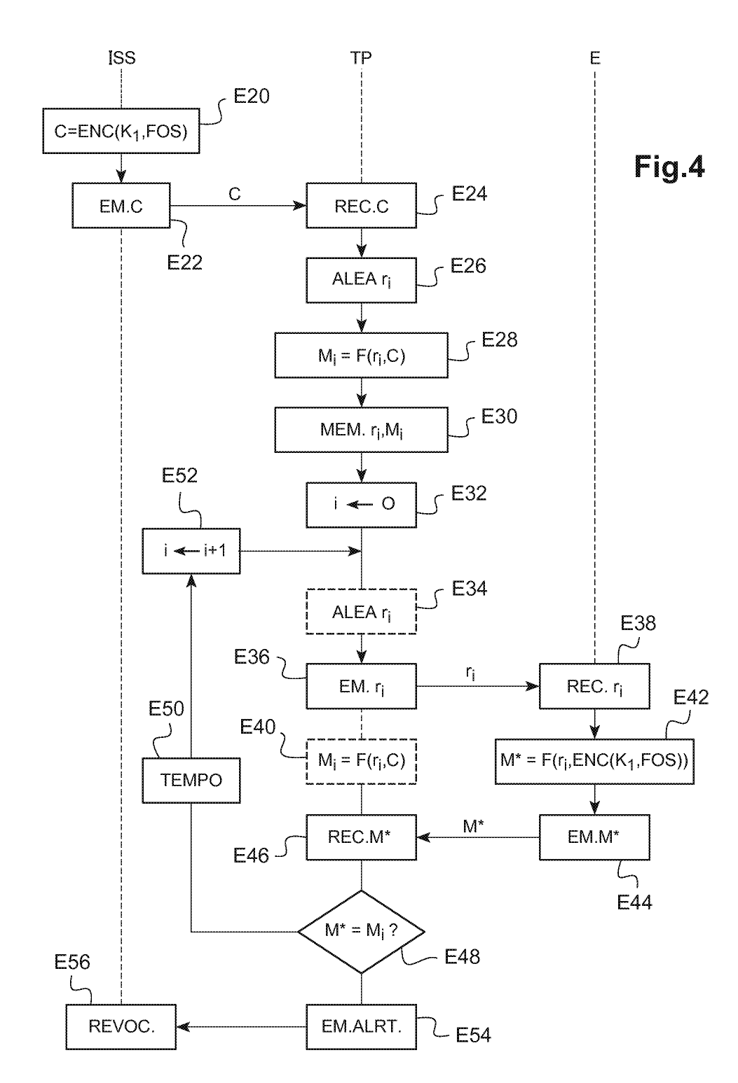

FIG. 4 represents the main steps of a second example of a method used in the context of the invention;

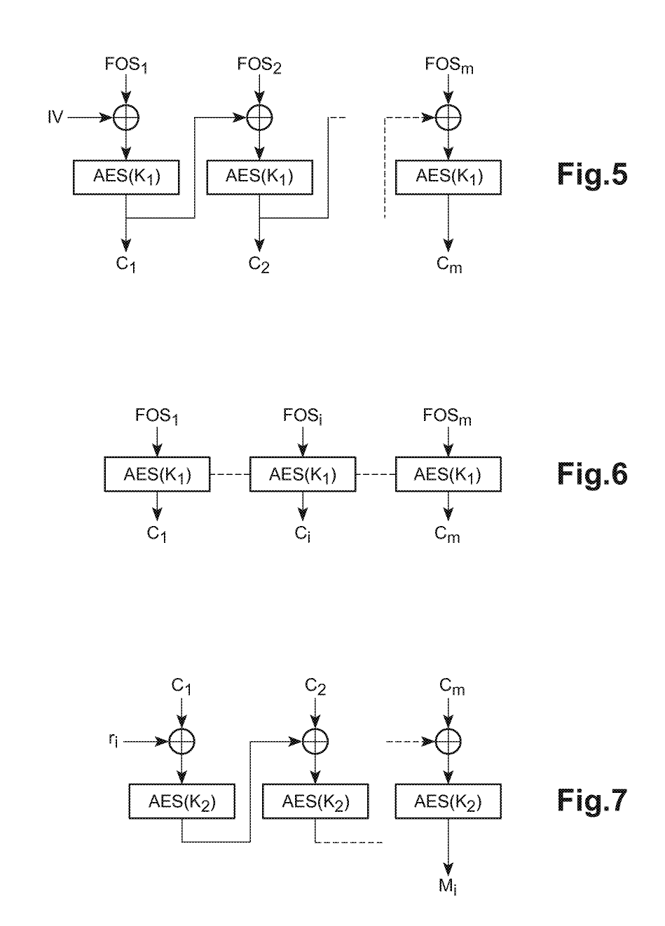

FIGS. 5 to 7 represent diagrammatically algorithms that can be used in the context of the method from FIG. 4;

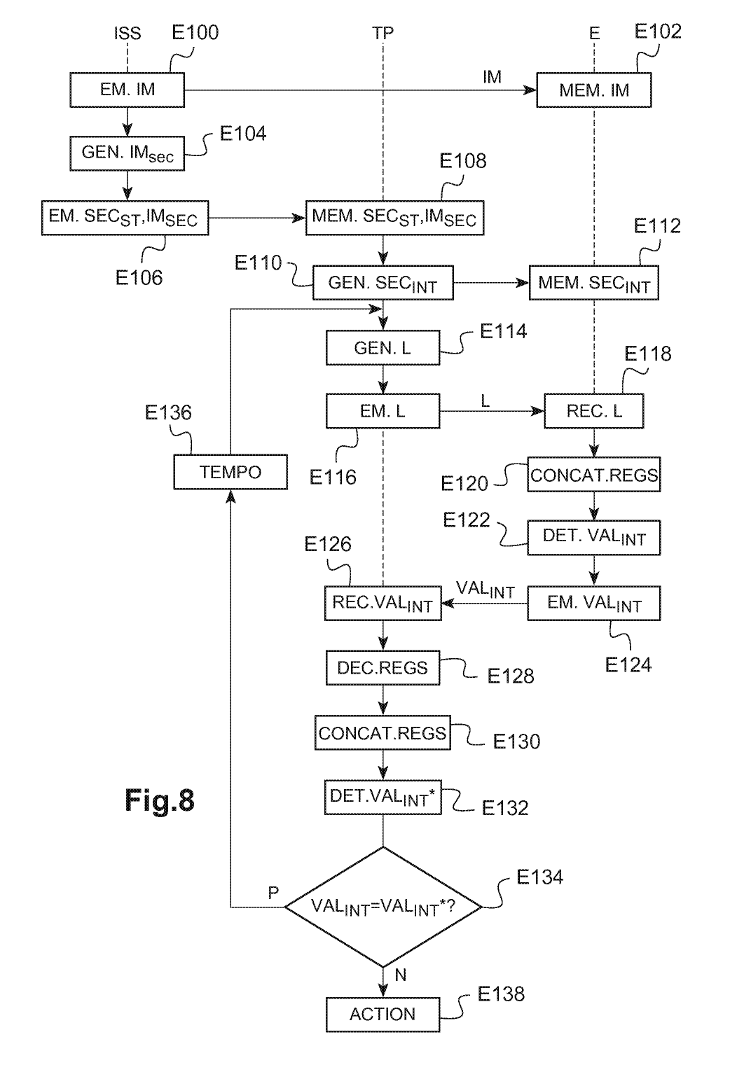

FIG. 8 represents the main steps of a third example of a method used in the context of the invention; and

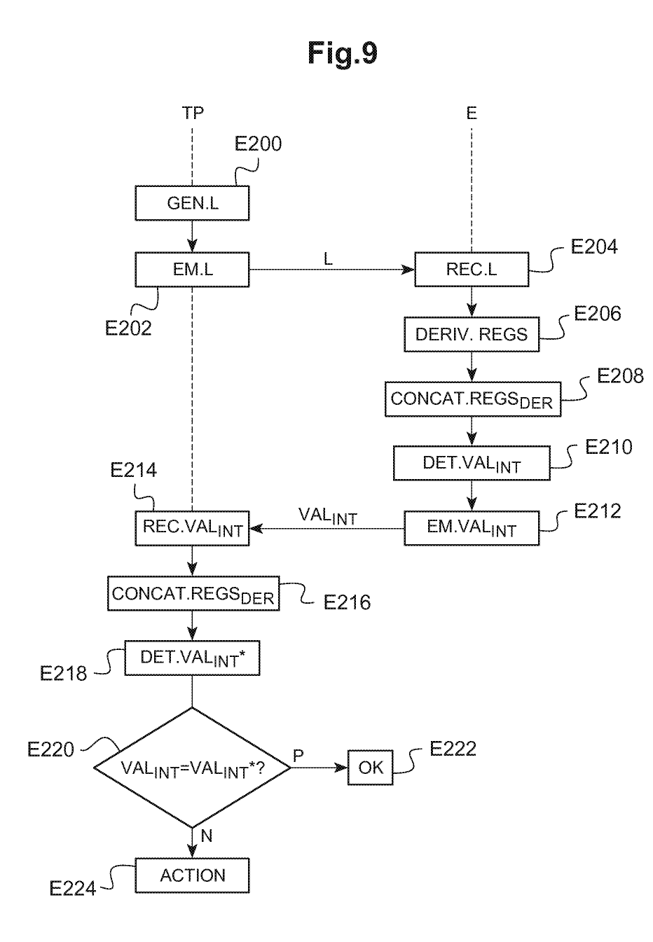

FIG. 9 represents the main steps of a fourth example of a method used in the context of the invention.

FIG. 1 represents a system in which a secure electronic entity according to the invention is used.

Such a system comprises electronic apparatus A provided with a communication module COM in order to exchange data with other electronic devices, as described hereinafter.

The electronic apparatus A can be a cellular and/or intelligent telephone (“smartphone”), a digital tablet or any other electronic apparatus that it is required to be able to exchange data with external electronic devices, for example an energy supply meter, a domestic appliance or an embedded electronic system in a motor vehicle.

The communication module COM enables bidirectional (here wireless) communication to be established with a network architecture N which is itself connected to the Internet network INT.

According to first embodiment, the network architecture N can be a mobile telephone network, in which case the communication module COM is designed to enter into communication with a base station of the mobile telephone network.

According to a second embodiment, the network architecture N can be an access point to a wireless local area network (WLAN), in which case the communication module COM is designed to connect to that local area network.

In both cases, the communication module COM enables access to the Internet network INT via the network architecture N.

Accordingly, a processor P (for example a microprocessor) of the electronic apparatus A connected to the communication module COM can exchange data with electronic devices (such as computers or servers) connected to the Internet network, notably a third party auditor (TPA) TP and an electronic entity issuer ISS.

The electronic apparatus A also comprises a secure electronic entity E, for example an integrated circuit card, possibly a universal integrated circuit card (UICC) according to the ETSI technical specification TS 102 221, an embedded secure element (eSE) according to the “GlobalPlatform Card Specification version 2.2.1” specification or another type of secure element. When the secure electronic entity E is an integrated circuit card, it can for example be a mobile telephone network access card, such as a card of universal subscriber identity module (USIM) type, or a secure token.

The secure electronic entity E can be removably mounted in the apparatus A (as is the case for an integrated circuit card produced in accordance with one of the 2FF, 3FF or 4FF formats or, generally speaking, a format smaller than the 2FF format), or non-removably (for example soldered) as in the case of an embedded secure element (an eSE as already referred to above) or an embedded integrated circuit card (also known as an eUICC or embedded universal integrated circuit card).

Here the secure electronic entity E is connected to the processor P of the electronic apparatus A and therefore has access via that processor P to the communication module COM. Alternatively, the secure electronic entity E could be connected directly to the communication module COM.

As shown in FIG. 1, the secure electronic entity itself comprises a microprocessor M, a random-access memory V and at least one non-volatile memory NV, for example a rewritable non-volatile memory of electrically erasable and programmable read-only memory (EEPROM) type or Flash memory type.

The non-volatile memory NV stores computer program instructions which, when they are executed by the microprocessor M, enable the execution of processes such as the processes described hereinafter by way of example.

The secure electronic entity E also stores data, notably confidential data such as that of secret keys (notably, for example, the cryptographic keys K₁, K₂ used in the examples given hereinafter).

The secure electronic entity E can therefore employ (as indicated above, because of the execution by its microprocessor M of instructions stored in the non-volatile memory NV, or even in the random-access memory V) employ an encryption method using a cryptographic key and/or a decryption method using a cryptographic key and/or a signature method using a cryptographic key and/or a method of generating an authentication code using a secret key and/or a method of generating a response to a challenge using a secret data item.

For each of these methods, the cryptographic key or the secret data item concerned is for example stored in the non-volatile memory NV.

In some cases, such as that referred to of a universal integrated circuit card or UICC, the secure electronic entity E can also employ methods of initiating and establishing remote communication via the communication module COM embedded in the electronic apparatus A that hosts the secure electronic entity E, for example by means of mechanisms such as those commonly referred to as SIM toolkits. The secure electronic entity E can then take the initiative to launch an exchange with remote electronic devices such as the third party auditor TP and the issuer ISS.

The program instructions and the data are stored (here in the non-volatile memory NV) in the form of bytes (for example 8-bit-bytes).

The secure electronic entity E is moreover designed, by virtue of its physical construction and the design of the computer programs that it stores, to make it very difficult or even impossible for a hacker to access (read and/or modify) the confidential data that it stores. Thus the secure electronic entity E has for example a Common Criteria assurance level EAL higher than 4 (ISO standard 15408), for example a level EAL4+ (VANS) or higher, and/or a Federal Information Processing Standard (FIPS) 140-2 level higher than 3.

The electronic apparatus A can also comprise a near field communication (NFC) module COM′. Alternatively, a wireless communication module of another type could be used, for example of Bluetooth, ZigBee or other type. Here, a near field communication module COM′ of this kind is connected directly to the secure electronic entity E, for example by means of a single wire protocol (SWP) type connection. Alternatively, the near field communication module COM′ could be connected to the processor P of the electronic apparatus A and could in that case exchange data with the secure electronic entity E via the processor P. The near field communication module COM′ is designed to enter into communication with a reader (here an NFC reader) when this module COM′ (and consequently likewise the electronic apparatus A) is positioned at a distance from the reader below a predetermined threshold, for example a threshold lower than 0.3 m.

The reader and the secure electronic entity E can therefore exchange data in accordance with a wireless communication protocol, for example in accordance with the ISO standard 14443. In particular, the reader can issue commands (such as application protocol data unit (ADPU) commands) via the wireless connection; the near field communication module COM′ receives these commands and transmits them to the secure electronic entity E (here via the SWP connection). The secure electronic entity E processes these commands (notably by means of processes executed in the secure electronic entity as described above) and issues responses (generated by the aforementioned processing) via the near field communication module COM′ and sent to the reader.

Thus, thanks to the confidential data stored in the secure electronic entity E and to the exchange possibilities provided by the near field communication module COM′, the electronic apparatus A can notably be used as means of identifying its holder, for example in payment applications (payment authorization), transport applications (access to the transport network via an automatic gate controlled by the reader), identity application, loyalty application, etc.

A first embodiment of the invention is described next with reference to FIGS. 2 and 3.

As can be seen in FIG. 2, in this first embodiment the non-volatile memory NV of the secure electronic entity E firstly stores a robotic operating system ROS and a factored operating system FOS.

The fixed operating system ROS is written into the non-volatile memory NV during the production of the secure electronic entity E, for example during a customization phase during which program instructions and customization data are written into the non-volatile memory NV, here with no possibility of subsequent modification.

The factored operating system FOS is also written into the non-volatile memory NV during the customization phase, but can be modified subsequently, for example remotely using a predefined procedure in which the microprocessor M of the secure electronic entity E enters into communication with a remote server (for example via the communication module COM) and writes in the non-volatile memory NV data received from the remote server, for example after a step of authentication of the remote server. According to one variant that can be envisaged, such an operating system could be loaded into random access memory for execution.

As can also be seen in FIG. 2, the third party auditor TP stores a plurality or random values r₁, . . . , rₙ and a plurality of verification values M₁, . . . , Mₙ associated with respective aforementioned random values. The verification values Mᵢ are not communicated to the secure electronic entity E. The random values rᵢ are successively communicated to the secure electronic entity E in a manner distributed across the duration of use of the secure electronic entity E, as explained hereinafter.

The number n of random values rᵢ (and of associated verification values Mᵢ) used is for example such that the secure electronic entity E cannot store all of these values rᵢ, Mᵢ.

For example, during a phase of evaluation of the factored operating system FOS during which the third party auditor TP has knowledge of the data forming the factored operating system FOS, it determines successively at random each of the random values rᵢ and calculates the associated verification value Mᵢ by applying a function F to that random value rᵢ and to the data that forms the factored operating system FOS:

Mᵢ=F(rᵢ,FOS).

The function F is such that it is impossible to determine F(rᵢ,FOS) without having knowledge of all of the data forming the factored operating system FOS and that the verification values Mᵢ provide no information as to the data forming the factored operating system FOS.

The function F is for example based on a hashing function H applied to the concatenation of the random value rᵢ and the data forming the factored operating system FOS: F(rᵢ,FOS)=H(rᵢ∥FOS), where ∥ is the concatenation operator. The hashing function H used is for example of SHA-256, SHA-512 or SHA-3 type.

Alternatively, the function F could be a message authentication code (MAC) generator function using a secret key K₂ and again applied here for example to the concatenation of the random value rᵢ and data forming the factored operating system FOS: F(rᵢ,FOS)=MAC(K₂,rᵢ ∥ FOS). The MAC function used is for example of HMAC type (based for example on SHA-256), CMAC or CBC-MAC type (based for example on the AES algorithm).

In the case of using a message authentication code generator function, the secret key K₂ is stored by the third party auditor TP for the calculation of the verification values Mᵢ as just indicated and by the secure electronic entity E for the calculation of a proof element as explained below. According to a variant that may be envisaged, there could be used (rather than a message authentication code) a signature produced by means of a private key of a public key infrastructure (PKI).

Note that for the application of the function F, the raw form of the bytes stored in the zone concerned (notably the data forming the factored operating system FOS) is considered independently of the form that represents those bytes during use of the secure electronic entity E (the bytes can for example represent as indicated above instructions that can be executed by the microprocessor M, customization data, confidential data such as secret keys, or even data that is not used).

FIG. 3 represents a method of exchange of data between the third party auditor TP and the secure electronic entity E in order to verify that the factored operating system FOS does indeed conform to that which has been evaluated (for example to certify it) in the evaluation phase. Clearly after this evaluation phase the third party auditor TP generally no longer has access to the factored operating system FOS.

This exchange of data between the third party auditor TP and the secure electronic entity E is for example effected via the Internet network INT, the network architecture N, the communication module COM and the processor P of the electronic apparatus A, as explained above with reference to FIG. 1.

The method begins in the step E2 with the third party auditor TP sending one of the random numbers rᵢ to the secure electronic entity. A step of this kind is executed periodically, for example.

According to a first embodiment, the random number rᵢ sent during the step E2 is chosen at random from the plurality of random numbers r₁, . . . , rₙ stored in the third party auditor TP (which can in practice be done by determining the index i used at random from the integers between 1 and n inclusive). According to a second embodiment, the random numbers r₁, . . . , rₙ, are used sequentially, one after the other.

The secure electronic entity E receives the random number rᵢ in the step E4.

The secure electronic entity E (in practice its microprocessor M, which uses the random-access memory V for this purpose) then determines in the step E6 the verification value associated with the random number rᵢ received using the same process as that used by the third party auditor TP during the evaluation phase, here by applying the function F to the random number rᵢ received and to the data forming the factored operating system FOS. The verification value calculated in this way by the secure electronic entity is denoted M*:

M*=F(rᵢ,FOS).

The calculated verification value M* is sent to the third party auditor TP in the step E8 as a proof element aiming to affirm that the factored operating system FOS has not been modified.

The third party auditor TP receives the verification value M* in the step E10 and compares it in the step E12 to that calculated during the evaluation phase.

Because of the properties of the function F indicated above, if the verification value M* calculated by the secure electronic entity E is equal to the verification value Mᵢ stored by the third party auditor TP the memory image corresponding to the factored operating system FOS is indeed the one expected and the secure electronic entity can continue to operate normally (step E16).

On the other hand, if the verification value M* calculated by the secure electronic entity E differs from the verification value Mᵢ stored by the third party auditor TP, that means that the factored operating system FOS does not conform to that which has been evaluated. There follows in this case the step E14 in which the problem encountered is processed, for example by sending a message to the issuer ISS of the secure electronic entity E, which can for example revoke the rights associated with the secure electronic entity E.

Note that as the value rᵢ cannot be predicted the secure electronic entity E cannot calculate and store beforehand the associated verification value Mᵢ (which would enable the secure electronic entity E to return the expected value even if the operating system FOS were modified afterwards). In other words, the data of the operating system FOS stored in the non-volatile memory NV on reception of the unpredictable (here random) value rᵢ must conform to that present during the evaluation phase so that the secure electronic entity E can calculate a verification value M* equal to the expected value M.

Note further that all of the data stored in the modifiable zone of the non-volatile memory NV (which is the zone in which the factored operating system FOS is stored) is used in the calculation of each verification value Mᵢ so that the secure electronic entity E cannot store a copy of the factored operating system that would enable it to calculate a correct verification value Mᵢ even after (unauthorized) modification of the factored operating system FOS.

Finally, as indicated above, the secure electronic entity E is not able to store all of the random values rᵢ and verification values Mᵢ and therefore is not able to respond to the third party auditor TP using a verification value determined previously and then stored (which would enable it to modify the factored operating system FOS after processing all of the random values r₁, . . . , rₙ and storing the associated verification values M₁, . . . , Mₙ).

A second embodiment of the invention is described next with reference to FIG. 4. This embodiment also concerns the situation in which a factored operating system FOS stored in the non-volatile memory NV of a secure electronic entity E is verified by a third party auditor TP, as represented diagrammatically in FIG. 2.

In this second embodiment the third party auditor TP nevertheless at no time has a knowledge of the data (in clear) forming the factored operating system FOS but has access only to an encrypted version C of that data, as explained next. Note that, if the third party auditor TP also has a certification role, the encrypted version C of the data can nevertheless be generated during an initial audit phase, under the surveillance of the certification body.

FIG. 4 represents the main steps of a second example of a method used in the context of the invention.

Thus this method begins in the step E20 which is a step of encryption of the data forming the factored operating system FOS by the issuer ISS of the secure electronic entity ISS. This encryption step is for example executed by applying to the data forming the factored operating system FOS an ENC encryption algorithm (here a symmetrical algorithm) using a secret key K₁ stored by the issuer ISS and by the secure electronic entity E (and known only to those two entities).

In the context of its encryption, the factored operating system FOS is for example divided into ordered blocks FOSⱼ of predetermined size (here 16 8-bit-bytes).

According to a first embodiment, the encryption algorithm ENC is of cipher block chaining (CBC) type and is applied as shown in FIG. 5: the first block FOS₁ is combined with an initialization vector IV (which is either predetermined or determined during the calculation, for example at random) by applying an “exclusive or” (XOR) operator, i.e. by Boolean summation, after which an AES encryption algorithm is applied with the secret key K₁ to the result of the combination in order to obtain the first encrypted block C₁; for the other blocks of data of the factored operating system FOS the block concerned FOSⱼ and the preceding encrypted block Cⱼ₋₁ are combined by means of an “exclusive or” operator (Boolean summation), after which the AES encryption algorithm is applied with the secret key K₁ to the result of the combination in order to obtain the encrypted version Cⱼ of the current block.

According to a second embodiment, the encryption algorithm ENC is of encoded codebook (ECB) type and is applied as shown in FIG. 6: an AES encryption algorithm using the encryption key K₁ is applied separately to each block FOSⱼ in order to obtain the encrypted version Cⱼ of the block concerned.

According to a third embodiment, the encryption algorithm is of counter (CTR) type: a counter incremented block by block is encrypted by means of an encryption algorithm such as the AES encryption algorithm using a secret key (for example the key K₁); the encrypted version Cⱼ of the block concerned is obtained by Boolean summation of the corresponding block FOSⱼ and the encrypted counter.

Whichever embodiment is used, the concatenation of the encrypted blocks Cⱼ obtained forms the encrypted version C of the factored operating system FOS.

The encrypted version C of the factored operating system FOS obtained in the step E20 is sent to the third party auditor TP in the step E22.

The third party auditor TP therefore receives the encrypted version C of the factored operating system FOS in a step E24, for example as indicated above in the form of encrypted blocks Cⱼ.

The third party auditor TP then determines in the step E26 a plurality of numbers r₁, . . . , rₙ, at random.

For each random number rᵢ determined in this way, the third party auditor TP determines in the step E28 an associated verification value Mᵢ, for example by applying a function F to the random number rᵢ concerned and to the encrypted version C of the factored operating system FOS.

The function F has properties identical to that used in the first embodiment. Moreover, as indicated for the first embodiment, a number n of random values rᵢ and of verification values Mᵢ can be used such that the secure electronic entity E is not able to store all of those values rᵢ, Mᵢ.

There is used for example as the function F a cipher block chaining—message authentication code (CBC-MAC) type algorithm taking as the initialization vector the random value rᵢ and as the cryptographic function the AES encryption algorithm using a secret key K₂, as shown in FIG. 7.

The random values rᵢ and the associated verification values Mᵢ are stored by the third party auditor (step E30), as shown in FIG. 2.

Note that an alternative here is to refrain from determining the random values rᵢ and verification values Mᵢ beforehand and storing them (see below steps E34 and E40). In effect, the factored operating system FOS being stored by the third party auditor TP in encrypted form, it can retain this data in memory throughout the use of the secure electronic entity E.

When the secure electronic entity E is used (the third party auditor TP can be informed of this by receiving—this is not shown in FIG. 4—a message from the issuer ISS), the third party auditor TP periodically verifies the integrity of the factored operating system FOS as described now.

In the example described here, an index i is first initialized to zero (step E32).

In the variant mentioned above in which the random values rᵢ are not determined beforehand, a value rᵢ is then determined at random in the step E34 (this step is naturally not executed if the step E26 was executed beforehand).

Whenever the random value rᵢ is determined (beforehand in the step E26 or on the fly in the step E34), the random value rᵢ is sent by the third party auditor TP to the secure electronic entity E in the step E36.

The secure electronic entity E receives the random value rᵢ in the step E38.

The secure electronic entity E then determines in the step E42 a verification value M* on the basis of the random value rᵢ and the data forming the factored operating system FOS by encrypting the data forming the factored operating system FOS by means of the encryption algorithm ENC and the secret key K₁ used in the step E20 and using the function F used in the step E28:M*=F(rᵢ,ENC(K₁,FOS)).

It must be remembered that to this end the secure electronic entity E stores the secret key (or cryptographic key) K₁ and when the function F is of CBC-MAC type as indicated above the secret key (or cryptographic key) K₂. Moreover, when the initialization vector IV used by the issuer ISS to encrypt the data forming the operating system FOS (see step E20 above) is obtained at random, this initialization vector IV is also stored in the secure electronic entity E. In the variant mentioned above in which the verification values Mᵢ are not determined beforehand, the third party auditor TP determines at this time in the step E40 (or possibly before sending of the random value rᵢ in the step E36) the verification value M; associated with the random value rᵢ obtained in the step E34 by applying the function F to that random value rᵢ and to the encrypted version C of the factored operating system FOS:Mᵢ=F(rᵢ,C). This step is naturally not executed if the step E28 is executed beforehand.

As indicated above, in the foregoing examples the function F is applied to all of the modifiable data from the non-volatile memory NV (i.e. in some cases all of the data from the non-volatile memory NV).

However, there can equally be envisaged applying the function F in steps E40 and E42 to only a part of the non-volatile memory NV or of the factored operating system FOS, for example to only some of the blocks FOSᵢ forming the factored operating system FOS.

When the factored operating system FOS is encrypted in the step E20 using an ECB (or CTR) type algorithm, for example, the third party auditor TP can therefore send the secure electronic entity E in the step E36 a designation of the blocks FOSᵢ to which the function F must be applied, for example in the form of a list {k(1), . . . , k(l)} of the indices i of those blocks (determined at random for example) and the verification words Mᵢ, M* can then be determined by concatenating the blocks concerned:
on the third party auditor TP side (step E40), Mᵢ=F(rᵢ,Cₖ₍₁₎∥ . . . ∥Cₖ₍ₗ₎);
on the secure electronic entity E side (step E42), M*=F(rᵢ, ENC(K₁,FOSₖ₍₁₎)∥ . . . ∥ENC(Kᵢ,FOSₖ₍ₗ₎).

In all cases, in the step E44 the secure electronic entity E sends the third party auditor TP the verification value M* determined in the step E42 as a proof-of-integrity element of the factored operating system FOS (or a part thereof).

The third party auditor TP can therefore in the step E48 compare the verification value Mᵢ it has determined (E28 or E40) with the verification value M* received from the secure electronic entity E.

If the result of the comparison is positive, the factored operating system FOS stored in the secure electronic entity E corresponds to the one expected and the third party auditor TP can wait a predetermined time (the time delay of the step E50) before incrementing the index i (step E52) and looping to the step E36 (or E34 in the variant mentioned above) in order to verify again the integrity of the factored operating system FOS.

If the result of the comparison is negative the factored operating system FOS (or, generally speaking, the memory zone covered by the verification) has been modified and for example the third party auditor TP sends an alert message to the issuer ISS (step E54). On receiving this alert message, the issuer ISS applies measures to deactivate the secure electronic entity, for example, such as revocation of the certificates stored in the secure electronic entity (step E56).

FIG. 8 shows the main steps of a third embodiment of a method used in the context of the invention.

During a step E100 the issuer ISS transmits a memory image IM to the secure electronic entity E. That memory image IM contains all of the data and instructions to be stored in the non-volatile memory NV of the secure electronic entity E to enable it to function.

The secure electronic entity E receives the memory image IM in the step E102 and stores it in its non-volatile memory NV. The secure electronic entity is then ready to be used for the functionality for which it is designed, for example as payment means, mobile telephone network access means, identification means, etc.

The steps E100 and E102 can be executed in the context of FIG. 1, in which case a mechanism for securing the exchanges between the issuer ISS and the secure electronic entity E is used beforehand in order to customize remotely the secure electronic entity E. Alternatively, the steps E100 and E102 can be executed in an establishment dedicated to the customization of secure electronic entities, in which case the secure electronic entity E communicates (via a wired or short-range wireless or other connection) with a customization machine of the issuer ISS (the customization machine then executing the step E100).

During a step E104 the memory image IM is made secure by the issuer ISS, for example by encryption using a cryptographic algorithm employing the cryptographic key SEC_{ST}, which enables a secure (here encrypted) version IM_{SEC} of the memory image IM to be obtained. The issuer ISS can possibly moreover generate a signature or an authentication code (or message authentication code (MAC)) of the memory image IM.

The secure memory image IM_{SEC} and the cryptographic key SEC_{ST} (as well as the signature or the authentication code where applicable) are sent by the issuer ISS to the third party auditor TP in the step E106. The cryptographic key SEC_{ST} being a secret shared between the issuer ISS and the third party auditor TP (or alternatively between the issuer ISS and a hardware security module held by the third party auditor TP), it is sent using a mechanism preventing its disclosure, for example by means of a secure channel set up between the issuer ISS and the third party auditor TP.

In the step E108 the third party auditor TP receives and stores the secure memory image IM_{SEC} and the cryptographic key SEC_{ST} (and where applicable the signature or the authentication code). In practice, the cryptographic key SEC_{ST} is for example stored in a hardware security module (HSM) of the issuer ISS, for example an integrated circuit card or an embedded secure element.

Then, during a step E110, the third party auditor generates a secret SEC_{INT} (for example at random) and stores that secret SEC_{INT}, for example in the aforementioned hardware security module.

The secret SEC_{INT} generated in the step E110 is sent to the secure electronic entity E, for example by means of a secure communication channel established between the third party auditor TP and the secure electronic entity E, and then stored in the secure electronic entity E (step E112), for example in a zone of the non-volatile memory NV not covered by the integrity verification.

In the example that has just been given, the secret SEC_{INT} is generated by the third party auditor TP. Alternatively, the secret SEC_{INT} could be generated by the issuer ISS, sent to the third party auditor ISS (for example in the step E106 described above) and stored in the secure electronic entity E during the customization phase (for example in the step E102 described above).

During use of the secure electronic entity E the third party auditor TP can then periodically verify the integrity of the parts of the memory image IM stored in the non-volatile memory NV, as described next.

In the step E114 the third party auditor TP generates an (ordered) unpredictable list L of regions of the memory zone the integrity of which has to be verified, here the non-volatile memory NV (which in normal operation contains the memory image IM received and stored in the step E102).

Here each region from the list L is defined by an address that designates the beginning of the region concerned (in other words the first 8-bit-byte of the region concerned, for example) and by a length (expressed for example as a number of words made up of bits, here as a number of 8-bit-bytes).

For each region from the list L the address and the length defining that region are determined at random, for example. However, in this case some particular parts of the memory concerned (here the non-volatile memory NV), for example parts containing critical or sensitive data or instructions, are more frequently targeted by the regions from the list. To this end, some addresses are for example determined at random from the addresses situated in these particular parts of the memory concerned, while other addresses are determined at random from all the feasible addresses for the memory concerned.

Alternately, the list of regions could be predetermined (whilst preferably remaining unpredictable). The third party auditor TP can in effect in practice use a large number of predetermined lists such that the secure electronic entity E could not store the expected response (the integrity value VAL_{INT} referred to below) to each of these lists.

According to another embodiment, the third party auditor TP can choose the list L at random from a large number of predetermined lists.

In the situation described here where the list is not predetermined, the number of regions listed in the list L can be fixed or variable, for example determined at random between a minimum value and a maximum value.

Note moreover that the various regions from the list L can possibly overlap (i.e. intersect) without this causing problems in the remainder of the process.

The third party auditor TP then sends the list L (generated in the step E114) to the secure electronic entity E in the step E116.

The unpredictable list L is received by the secure electronic entity E in the step E118.

The secure electronic entity E then constructs an 8-bit-byte structure in the step E120 by reading the 8-bit-bytes stored in the memory regions (here regions of the non-volatile memory NV) designated in the list L received, for example by concatenation of the 8-bit-bytes read in the regions from the list L.

The secure electronic entity E can thus determine an integrity value (or verification value) VAL_{INT} in the step E122 by applying a function f to the 8-bit-byte structure produced in the step E120, here also using the secret SEC_{INT}. The function f is for example a signature cryptographic function or a message authentication code generation cryptographic function using the secret SEC_{INT} as the cryptographic key and the aforementioned 8-bit-byte structure as the message (to be signed or authenticated). The function f can be of one of the types proposed above (in the context of the first two embodiments) for the function F.

As for the function F, the function f is applied considering the raw form of the bytes (here 8-bit-bytes) of the structure, independently of what those bytes represent during use of the secure electronic entity E.

Note that the function f can possibly use other parameters (for example a random value) that in this case are sent either from the third party auditor TP to the secure electronic entity E with the list L in the step E116 or from the secure electronic entity E to the third party auditor TP with the integrity value VAL_{INT} in the step E124 (described below). Those other parameters comprise for example an initialization vector used by the function f (notably when the function f is of CBC-MAC type).

The integrity value VAL_{INT} calculated by the secure electronic entity E in the step E122 is sent to the third party auditor TP in the step E124.

The third party auditor TP receives and stores this integrity value VAL_{INT} in the step E126.

The third party auditor TP then reads in the secure memory image IM_{SEC} the parts corresponding to the regions from the list L and decrypts the parts that have been read by means of the cryptographic key SEC_{ST} (step E128). Alternatively, the decryption is performed by the hardware security module (inside the latter) so that the third party auditor TP has no knowledge of the decrypted versions.

The third party auditor TP (or where applicable the hardware security module) can possibly at this time verify the signature or the associated authentication code when an element of this kind was sent during the step E106 as mentioned above.

The third party auditor TP (or alternatively the hardware security module held by the third party auditor TP) can then in the step E130 produce an 8-bit-byte structure from the 8-bit-bytes contained in the decrypted parts using the method employed by the secure electronic entity E in the step E120, here by concatenation of those 8-bit-bytes. The data structure obtained in the step E130 is normally (i.e. in the case of normal operation, with no modification of the memory image IM) identical to that obtained in the step E120.

The third party auditor TP (or alternatively the hardware security module held by the third party auditor TP) determines in the step E132 an integrity value VAL_{INT}* from the 8-bit-byte structure obtained in the step E130 using the same method as that employed in the step 122, i.e. by applying the function f to this 8-bit-byte structure produced in the step E130, here also using the secret SEC_{INT}.

The third party auditor TP (or alternatively the hardware security module held by the third party auditor TP) can therefore verify in the step E134 whether the integrity value VAL_{INT} calculated by the secure electronic entity E is indeed equal to the integrity value VAL_{INT}* calculated in the step E132. When the steps that have just been described are executed by the hardware security module held by the third party auditor TP (so that the third party auditor TP itself cannot have any knowledge of the content of the verified memory), a message indicating the result of the comparison is sent from the hardware security module to the third party auditor TP.

If the verification is positive, the memory image IM stored in the non-volatile memory NV of the secure electronic entity E has not been degraded and the secure electronic entity E can therefore continue to be used normally.

In this case the method therefore continues with a time-delay step E136 before the execution of a new iteration of the verification of the integrity of the memory image IM starting from the step E114 as described above.

If the verification of the step E134 is negative, the process instead continues with the step E138 during which action is taken to process the integrity fault of the memory image detected in this way. That action (which is not represented in FIG. 8) is for example the sending of a message indicating this integrity fault to the issuer ISS, which can then for example revoke the rights associated with the secure electronic entity E or alternatively impose remote updating of the memory image of the non-volatile memory NV.

The integrity verification iteration described above can verify only the integrity of the data contained in the regions from the list L used during that iteration. However, as the iterations proceed, a larger part of the memory concerned will have been verified. Note further that the secure electronic entity E is not able to predict the regions used during a given iteration and therefore cannot anticipate the integrity value sent in response to the third part auditor TP.

The only way for the secure electronic entity E to calculate the expected response is therefore to maintain the integrity of the memory concerned.

FIG. 9 shows the main steps of a fourth embodiment of a method used in the context of the invention.

In this embodiment, the third party auditor TP stores a derived memory image IM_{DER} obtained from the memory image IM (stored in the non-volatile memory NV of the secure electronic entity E), for example by means of an encryption cryptographic algorithm (such as an ECB type algorithm as mentioned above). This situation is for example produced by a method of the same type as that of the steps E20 to E24 described above with reference to FIG. 4.

The secure electronic entity E stores the encryption cryptographic key used to produce the derived memory image IM_{DER}.

An iteration of the method of verifying the integrity of the memory image IM is described below. This kind of iteration is repeated periodically in order progressively to cover an increasingly large part of the memory concerned, as described above with reference to FIG. 8 for the third embodiment.

In the step E200 the third party auditor TP generates an (ordered) unpredictable list L of regions of the memory zone the integrity of which is to be verified, here the non-volatile memory NV.

As in the third embodiment described above with reference to FIG. 8, each region from the list L is defined here by an address and by a length. The list L of the regions is generated in one of the ways envisaged above in the context of the third embodiment.

The third party auditor TP sends the list L to the secure electronic entity E (step E202) and the unpredictable list L is therefore received by the secure electronic entity E in the step E204.

The secure electronic entity E then reads the data stored (in the form of bytes, here 8-bit-bytes) in the regions designated in the list L and in the step E206 generates corresponding derived data by applying the algorithm used to produce the derived image IM_{DER} stored by the third party auditor TP as indicated above (here an encryption algorithm, for example of EBC type, using the encryption cryptographic key stored by the secure electronic entity E). In the step E208 the electronic entity then constructs a data structure (or 8-bit-byte structure) to be processed using the derived data produced in the step E206, for example by concatenation of that derived data.

The secure electronic entity E can therefore determine in the step E210 an integrity value (or verification value) VAL_{INT} by applying a function f to the data structure produced in the step E208, also using for example a secret key SEC_{INT} shared between the secure electronic entity E and the third party auditor TP, as in the third embodiment described with reference to FIG. 8. The function f can be of one of the types proposed above (in the context of the first three embodiments).

The integrity value VAL_{INT} calculated by the secure electronic entity E in the step E210 is sent to the third party auditor TP in the step E212 and received by the latter, which stores it, in the step E214.

The third party auditor TP then reads in the derived memory image IM_{DER} the parts corresponding to the regions from the list L and in the step E216 produces a data structure from the read data using the method employed by the secure electronic entity E in the step E208, here by concatenation of the read data. The data structure produced in the step E216 is normally (i.e. in the case of normal operation with no modification of the memory image IM) identical to that produced in the step E208.

In the step E218 the third party auditor TP determines an integrity value VAL_{INT}* from the data structure produced in the step E216 by the same method as that used in the step E210, i.e. by applying the function f to this data structure produced in the step E216, here also using the shared secret SEC_{INT}.

The third party auditor TP can therefore verify in the step E220 whether the integrity value VAL_{INT} calculated by the secure electronic entity E is indeed equal to the integrity value VAL_{INT}* calculated in the step E218.

If the verification is positive, the memory image IM stored in the non-volatile memory NV of the secure electronic entity E has not been degraded and the secure electronic entity E can therefore continue to be used normally (step E222).

If the verification of the step E220 is negative, the process continues instead with the step E224 during which action is taken to process the integrity fault of the memory image IM detected in this way. That action is of the same type as that of the step E138 described above with reference to FIG. 8.

1. A secure electronic entity comprising:
a memory storing data in the form of bytes;
a processor module designed to receive data coming from an electronic device;
wherein the processor module is designed to determine a proof-of-integrity element as a function of the data received and at least a part of the stored bytes and to send the proof-of-integrity element to the electronic device.

2. The secure electronic element as claimed in claim 1 in which the received data represents a random value.

3. The secure electronic entity as claimed in claim 1 in which the receive data designates regions of the memory and in which the processor module is designed to determine the proof-of-integrity element as a function of the bytes stored in the regions designated by the received data.

4. The secure electronic entity as claimed in claim 1 in which the processor module is designed to determine the proof-of-integrity element in part by means of encryption of the stored bytes.

5. The secure electronic entity as claimed in claim 4 comprising a module for executing the encryption as a function of a secret key stored in the secure electronic element.

6. The secure electronic element as claimed in claim 1 in which the processor module is designed to determine the proof-of-integrity element by means of a signature function or a hashing function or a message authentication code generator function.

7. The secure electronic entity as claimed in claim 1, said secure electronic entity being a mobile telephone network access card.

8. A cellular telephone comprising a secure electronic entity as claimed in claim 1.

9. The cellular telephone as claimed in claim 8 in which the secure electronic entity is soldered to the cellular telephone.

10. An energy supply meter comprising a secure electronic entity as claimed in claim 1.

11. The energy supply meter as claimed in claim 10 in which the secure electronic entity is soldered to said meter.

12. An embedded electronic system for vehicles comprising a secure electronic entity as claimed in claim 1.

13. The embedded electronic system as claimed in claim 12 in which the secure electronic entity is soldered to the electronic system.

14. An electronic apparatus comprising a near field communication module and a secure electronic entity as claimed in claim 1 connected to the near field communication module.

15. A method of verifying the integrity of data stored in a secure electronic entity, comprising the following steps:
an electronic device sending data to the secure electronic entity;
the secure electronic entity receiving the data;
determination of a proof-of-integrity element as a function of the received data and at least some of the bytes stored in a memory of the secure electronic unit;
the secure electronic entity sending the proof-of-integrity element to the electronic device.

16. The verification method as claimed in claim 15 comprising a step of determining at least some of the data sent at random.

17. The verification method as claimed in claim 15 in which the received data represents a random value used as a parameter in the application of a function.

18. The verification method as claimed in claim 15 in which the received data designates regions of the memory and in which the proof-of-integrity element is determined as a function of the bytes stored in the regions designated by the received data.

19. The verification method as claimed in claim 15 in which the determination of the proof-of-integrity element comprises encryption of the stored bytes.

20. The verification method as claimed in claim 19 in which the encryption of the stored bytes uses a secret key stored in the secure electronic entity.

21. The verification method as claimed in claim 15 in which the proof-of-integrity element is determined by applying a signature function or a hashing function or a message authentication code generator function.

22. The verification method as claimed in claim 15 in which said electronic device is a third party auditor.
